(19) United States
(12) Patent Application Publication
(10) Pub. No.: US 2003/0046236 A1
(43) Pub. Date: Mar. 6, 2003

(54) Method and arrangement for paying electronically for a goods item or service, in particular an application in a data network

(76) Inventors: Andreas Berg, Berlin (DE); Uwe Klatt, Berlin (DE); Karsten Luettge, Berlin (DE); Thomas Ryll, Berlin (DE)

Correspondence Address: Kevin R. Spivak, Morrison & Foerster LLP, Suite 5500, 2000 Pennsylvania Avanue, N.W., Washington, DC, 20006-1888, US

(21) Appl. No.: 10/218,911

(22) Filed: Aug. 15, 2002

(30) Foreign Application Priority Data
Aug. 16, 2001 (DE) 10140335.6

(51) Int. Cl. G06F 17/60

(52) U.S. Cl. 705/44

(57) ABSTRACT

Method for paying an amount electronically, in particular a relatively large amount or a series of very small amounts for use of an application made available by a service provider in a data network, in particular the Internet, by a customer to a trader by involving a payment system server of a payment system provider, the payment being carried out by transmitting a confirmation message from a customer terminal via a mobile telephone network using USSD.

The invention relates to a method for paying electronically for a goods item or service as claimed in the preamble of claim 1, and to an arrangement for carrying out this method.

The use of services which are made available via the Internet—whether for the acquisition of information, for making contact with people, for making purchases or the like—is nowadays part of the everyday experience of hundreds of millions of computer users in the entire world. The introduction of transmission technologies with high performance capabilities in the field of mobile telecommunications has also opened up access to these applications to the users of mobile telephone terminals (assuming they have appropriate technical equipment). An increasing proportion of these applications are fee-paying so that when accessing via a mobile telephone network—as was still the case several years ago for access via a data terminal—there is the problem of finding a way of organizing payment operations which is organized in the simplest way possible and is cost-effective and yet reliable for customers and traders equally—which also applies to the acquisition of goods.

In quite general terms, three roles are involved in the use of an application in the mobile Internet:

The service provider is the provider of a service or of a goods item for which it requires payment.

The customer (consumer) is the user of an offered service and must pay for it.

The payment service provider (PSP) processes payments between the service providers and consumers. It is frequently identical to the operator of a mobile communications network, the network operator.

In the classic telecommunications world, the network operator acts both as service provider and as PSP. It provides telephone services to its customers and bills them via its existing billing system (postpaid or prepaid)—With the opening up of the telecommunications networks (for example by Parlay 3GPP TS 29.198), third parties which offer their own services (for example content providers) are also acting as service providers, as is also the case within public data networks (for example the Internet), but as a rule such third parties do not have their own billing service, and cannot, or do not wish to, acquire one either.

The PSP can trust the service provider if the latter indicates to him the business transaction of a service used by the customer and can dispense with an explicit statement of consent to billing by the customer. The PSP often does not wish to incur this risk and will often wish to acquire an explicit statement of consent for each payment procedure (or for a specific number of payment procedures of a fixed amount) from the customer, especially if the payments are for relatively large amounts.

In order to be able to acquire this statement of consent, there is a need for a channel from the PSP to the customer which does not pass via the service provider but instead is direct. This channel should be as far as possible independent of the type of terminal and should incur low costs for the PSP, but at the same time should be easy to operate by the customer and satisfy the security requirements.

The invention is therefore based on the object of making available a method and an arrangement for processing a payment procedure in accordance with these requirements.

This object is achieved in its method aspect by means of a method having the features of claim 1, and in its device aspect by means of an arrangement having the features of claim 10.

The present invention includes the idea of solving the problem of the lack of a mechanism for obtaining a statement of consent of a customer to one or more payment transactions using an established mechanism in mobile telecommunications networks (Unstructured Supplementary Service Data—USSD). This ensures a cost-effective introduction of this method.

In a payment system server, a decision signal relating to the request of a confirmation message is generated when there is imminent use of the application as a result of the checking of a customer profile of the customer. In response to a positive decision signal (“consent necessary”) which characterizes the request of the confirmation message a Network Initiated USSD string is emitted to a customer terminal via the mobile telephone network.

The customer usually triggers a use of the application by a mobile telephone terminal, in particular using GPRS or UMTS, and the MSISDN of the mobile telephone terminal which is transmitted in this triggering procedure is then transmitted as identifier of the customer to the payment system server by a service provider server.

The emission of the network initiated USSD string is carried out by means of a connection to the home file via MAP (Mobile Application Part) protocol 3GPP TS 29.002. Here, the request of a confirmation message typically starts from a service control node on which a prepaid account or even a postpaid account of the customer is administered.

The payment system server preferably extracts decision-related information, in particular a payment limit for a confirmation-free payment by the customer, and/or an authentication code of the customer via a data link to a central customer database.

Given a positive result of a check of the confirmation message in the payment system server, the debit procedure from an electronically administered account of the customer is triggered, and an execution message is then transmitted to the customer using USSD. The execution message is also emitted when interacting with the service control node on which, in particular, the prepaid account or postpaid account of the customer is administered, and with the home file of the mobile telephone network is executed.

According to established protocol structures, in each of the abovementioned USSD communications USSD, according to 3GPP 22.030 “Man Machine Interface MMI” for triggering an interrogation “*#SC*SI#” or a registration “*SC*SI#” is used, SC being a service code and SI representing an authentication code, in particular a PIN, which is input by the customer.

In terms of arrangements, it is to be noted that the connection between the service control node and the customer terminal is organized so as to be bidirectional via a home file of the mobile telephone network. The mobile switching center of the mobile telephone network is designed to support USSD MAP V2.

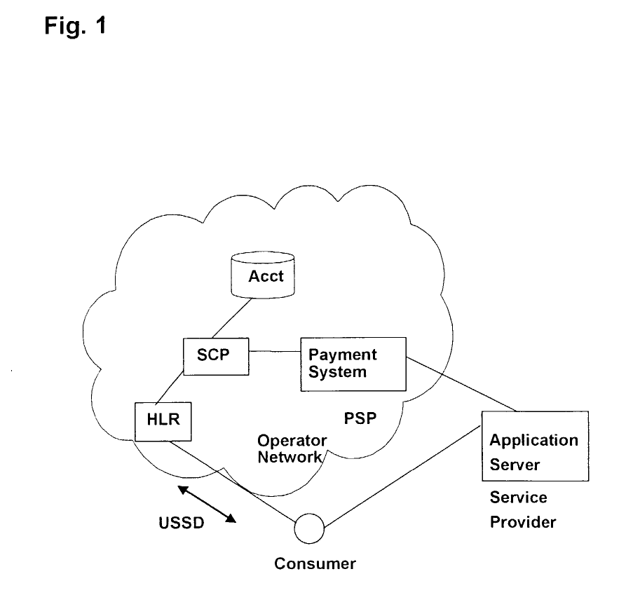

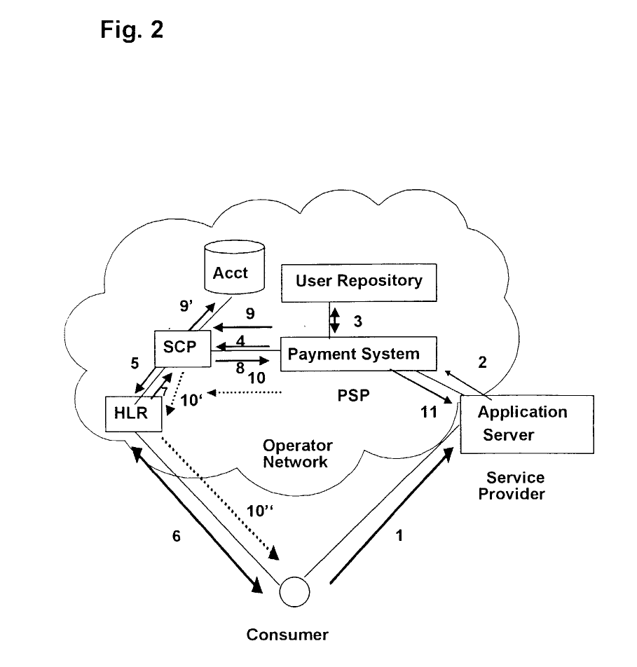

Advantages and expediencies of the invention also emerge from the following description of preferred exemplary embodiments or aspects with reference to FIGS. 1 and 2.

FIG. 1 shows the proposed architecture for the “User Confirmation” (confirmation message of the customer) of payment transactions with a defined amount. The triggering party is the customer who places himself in communication with the service server of the service provider from his mobile telephone terminal over any desired path. This could be, for example:

dialing in via a dial connection (RAS—Remote Access Server) and access to application server via TCP/IP (Web/WAP),

dialing in via GPRS and access to application server via TCP/IP (Web/WAP),

access to application server via SMS (short message service),

access to application server via IVR (interactive voice response).

A precondition in all cases is that the customer is a registered user (subscriber) of the network operator, that is to say has a commercial relationship with it and that he has access to his mobile telephone terminal when using the service.

If, when use of the service is imminent, the application service then makes use of a billing service of the network operator (for example via the OSA Open Service Access 3GPP 29.198 Charging IF), the billing service can then decide whether it is necessary to obtain confirmation by the customer for this payment transaction. This can be stored, for example, in the individual customer profile (for example obtain user confirmation for amounts over 5 DM). If this is the case, the billing service can then use a connection to the SCP (Service Control Point) to transmit a network initiated USSD string. This is done by the SCP via the connection to the HLR (Home Location Register) via the MAP protocol.

The USSD string is then fed to the mobile telephone terminal of the customer and could request him to input his personal PIN (Personal Identification Number). After this PIN has been input, the response message would be passed again via the HLR to the SCP which passes it on to the billing service. At this point, the billing service can compare the input PIN with one which is stored (for example on a central customer database), and if they correspond cause the amount to be debited at the SCP where the account is held.

After successful debiting, certification can be sent to the customer using USSD (“payment successful!”).

Advantages of the procedure described here are as follows:

it becomes possible to obtain a confirmation message which is independent of the service provider.

The method presented provides a reliable way of communicating with the consumer.

In comparison with other conceivable mechanisms (for example SMS), the method described here is defined by:

guaranteed delivery of the message,

extremely short transit times within the network.

The USSD mechanism is defined by a high level of user-friendliness.

The USSD mechanism is supported by virtually all mobile terminals.

Only small changes to the existing mobile telephone network are necessary as a result of the use of a standardized, already implemented mechanism (USSD). A precondition for the MSC (mobile switching center) is the support of SSD MAP V2.

The mechanism used gives rise to very small costs per user confirmation (for example in comparison with a method based on SMS) for the network operator as the expenditure is purely on signaling.

Use for prepaid and postpaid accounts.

As a result of the necessity to use a mobile telephone terminal in a payment procedure, the network operator ensures it is involved as PSP over the described path and a payment cannot take place without its involvement.

Payment@vantage is a real-time payment system which administers accounts for service providers.

This billing service is operated by the PSP. The prepaid accounts of the customers are located at SCPs (Service Control Points). The SCP uses the interface to the HLRs and in this way can initiate the emission of a network initiated USSD.

FIG. 2 illustrates, as an exemplary embodiment of the invention, the sequence in the billing for the use of a service of a third party service provider on a prepaid account. The individual steps have the following content:

Step 1: The user/customer dials in with his GPRS (General Packet Radio Services) terminal and would like to use a service of the service provider. The transmission of the data from the service provider to the customer and back is carried out by means of HTTP (Hypertext Transport Protocol).

Step 2: The application server makes use of the payment system of the PSP in order to initiate billing for the service. The content of this inquiry is the identification of the consumer (MSISDN) as well as information relating to price and guarantee of the use of the service.

Step 3: The payment system interrogates a central user repository and receives from it the information relating to individual limits of the customer above which the customer would like to give a confirmation message (for example 5 DM). It also receives the PIN of the customer.

Step 4: The payment system transmits to the SCP the request to obtain a confirmation message using USSD. In certain companies' systems, such a message is sent using what is referred to as the “online-IF” via TCP/IP.

Step 5: The SCP sends the message “unstructured_SS_Request” to the HLR by means of MSISDN using the protocol MAP.

Step 6: The customer is requested to input his personal PIN with a network initiated USSD. Corresponding USSDs according to 3GPP 22.030 “Man-Machine-Interface MMI” trigger an interrogation (‘*#SC*SI#’) or a registration (‘*SC*SI#’). Here, SC is a service code which is not reserved for GSM, and Sl is the supplementary information, that is to say for example ‘PIN?’.

Step 7: The HLR transmits the response of the customer back to the SCP. This message contains the input PIN of the customer.

Step 8: The SCP presses on the PIN to the billing service.

Step 9, 9′: The billing service compares the input PIN with that forwarded from the central customer database and if they correspond transmits a debiting message to the SCP. The latter extracts the transaction amount, transmitted by the service provider, from the account provided there is sufficient credit on the prepaid account of the customer, and acknowledges this to the payment system. The payment system can now credit this amount to an account of the service provider which is held there.

Step 10, 10′, 10″: The billing service requests the SCP to dispatch a notification message to the customer which informs the latter of the successful payment. A response from the customer is not necessary, the message is, as described above, initiated again via the HLR.

Step 11: The billing service informs the service provider of the successful debiting transaction, the service provider thus has its payment guarantee and can start to provide the service/deliver the product.

The customer/user is thus able to authorize payment above a specific amount with an individual confirmation, and the PSP has covered itself by obtaining the individual confirmation from the consumer (which confirmation was completely independent of the service provider), and can thus happily provide the service provider with a payment guarantee. The service provider in turn does not need to be concerned with all the aspects of a payment flow and can concentrate on providing the service.

1. A method for paying an amount electronically, in particular a relatively large amount or a series of very small amounts for use of an application made available by a service provider in a data network, in particular the Internet, by a customer to a trader by involving a payment system server of a payment system provider, characterized in that the payment is carried out by transmitting a confirmation message from a customer terminal via a mobile telephone network using USSD.

2. The method as claimed in claim 1, characterized in that a decision signal relating to the request of a confirmation message is generated in the payment system server when there is imminent use of the application as a result of the checking of a customer profile of the customer, and in response to a positive decision signal which characterizes the request of the confirmation message a network initiated USSD string is emitted to a customer terminal via the data and/or communications network.

3. The method as claimed in claim 2, characterized in that the emission of the network initiated USSD string is carried out by means of a connection to the home file via MAP protocol.

4. The method as claimed in claim 1, characterized in that the request of a confirmation message starts from a service control node on which a prepaid account of the customer is administered.

5. The method as claimed in claim 2, characterized in that the payment system server receives decision-related information, in particular a payment limit for a confirmation-free payment by the customer, and/or an authentication code of the customer via a data connection to a central customer database.

6. The method as claimed in claim 1, characterized in that when there is a positive result of a check of the confirmation message in the payment system server, a debit procedure from an electronically administered account of the customer is triggered, and an execution message is then transmitted to the customer terminal using USSD.

7. The method as claimed in claim 6, characterized in that the execution message is emitted when interacting with the service control node on which, in particular, the prepaid account or prepaid account of the customer is administered, and with the home file of the mobile telephone network.

8. The method as claimed in claim 1, characterized in that in the USSD communication USSD, or in each USSD communication USSD, according to 3GPP 22.030 “Man Machine Interface MMI” for triggering an interrogation “*#SC*SI#” or a registration “*SC*SI#” is used, SC being a service code and SI representing an authentication code, in particular a PIN, which is input by the customer.

9. The method as claimed in claim 1, characterized in that the customer triggers a use of the application by a mobile telephone terminal, in particular using GPRS or UMTS, and the MSISDN of the mobile telephone terminal which is transmitted in this triggering procedure is then transmitted as identifier of the customer to the payment system server by a service provider server.

10. An arrangement for carrying out the method as claimed in claim 1, characterized by a temporary bidirectional connection structure between the payment system server, a service control node of a USSD-capable mobile telecommunications network and a customer terminal connected to this mobile telephone network.

11. The arrangement as claimed in claim 10, characterized in that the connection between the service control node and the customer terminal is organized so as to be bidirectional via a home file of the mobile telephone network.

12. The arrangement as claimed in claim 10, characterized in that the mobile switching center of the mobile telephone network is designed to support USSD MAP V2.
